(19) United States
(12) Patent Application Publication
(10) Pub. No.: US 2002/0122662 A1
(43) Pub. Date: Sep. 5, 2002

(54) Constant speed control circuit for a fan

(76) Inventor: Hsin-Mao Hsieh, Pingtung City (TW)

Correspondence Address: BACON & THOMAS, PLLC, 4th Floor, 625 Slaters Lane, Alexandria, VA, 22314-1176, US

(21) Appl. No.: 09/796,625

(22) Filed: Mar. 2, 2001

(51) Int. Cl. H02P 5/00

(52) U.S. Cl. 388/800

(57) ABSTRACT

A constant speed control circuit for a fan includes a timing control circuit, a signal comparing circuit connected to the timing control circuit, a driving circuit connected to the timing control circuit, and a signal generating circuit. The signal comparing circuit receives an external frequency signal from a frequency generator and a timing signal from the timing control circuit. By comparing the external frequency signal and the timing signal, the signal comparing circuit outputs an correction output signal to the timing control circuit for driving coils of the fan through the driving circuit. The external frequency signal represents an expected rotational speed of the fan, and thus by providing a fixed frequency value, the fan is operated in a constant speed status.

### BACKGROUND OF THE INVENTION

1. Field of the Invention

The present invention relates to a constant speed control circuit for a fan, and more particularly to a control circuit which comprises a timing control circuit, a signal comparing circuit, a driving circuit and a signal generating circuit, wherein a rotational speed of a fan is steadily controlled.

2. Description of Related Art

Heat sinks fitted to microprocessors usually have an electric fan as a critical component to achieve optimum heat dissipation from the microprocessor. Thus, reliable performance of the fan is essential to the heat dissipation process, and ultimately performance of the microprocessor. The performance of the fan not only depends on the fan structure, but also depends on its control circuit. A common problem of such a fan is that rotational speed of the fan is not easy to be steadily controlled. Several factors that influence rotational speed are briefly described below.

1. Friction: Friction of a new fan is generally greater than an old fan because the bearings are new in the former and generally produced to be a little tight to allow for some wear during the life of the fan. Thus the different friction causes different rotational speeds during the life of a fan.

2. Temperature: When the temperature surrounding the fan rises, resistance of coils of the fan also increases, thus rotational speed of the fan gradually slows.

Further, in order to fit in different working environments, fans with different rotational speeds are required. Thus manufacturers of fans need to fabricate many different models of fans having different rotational speed specifications, hence the cost is increased due to the need for large stocks of fans.

To overcome the shortcomings, the present invention tends to provide a constant speed control circuit for a fan to mitigate and obviate the aforementioned problems.

### SUMMARY OF THE INVENTION

The main objective of the invention tends to provide a constant speed control circuit, which comprises a timing control circuit, a signal comparing circuit, a driving circuit and a signal generating circuit, so as to steadily control a rotational speed of the fan.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a constant speed control circuit in accordance with the present invention;

FIG. 2 is a circuit diagram showing that the constant speed control circuit of FIG. 1 is applied for controlling a pair of coils of a fan in accordance with the present invention; and

FIG. 3 is a circuit diagram showing that the constant speed control circuit of FIG. 1 is applied for controlling a single coil of a fan in accordance with the present invention.

### DETAILED DESCRIPTION OF THE PREFERRED EMBODIMENT

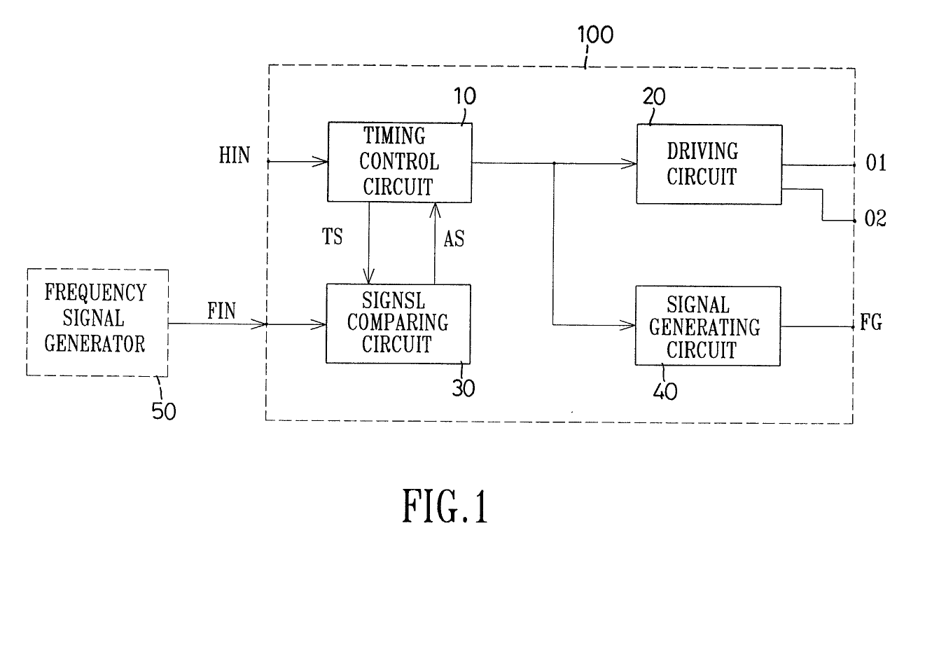

With reference to FIG. 1, a constant speed control circuit (100) in accordance with present invention comprises a timing control circuit (10), a driving circuit (20) connected to an output terminal of the timing control circuit (10), a signal comparing circuit (30) having an input terminal and an output terminal both connected to the timing control circuit (10), and a signal generating circuit (40) connected to the output terminal of the timing control circuit (10).

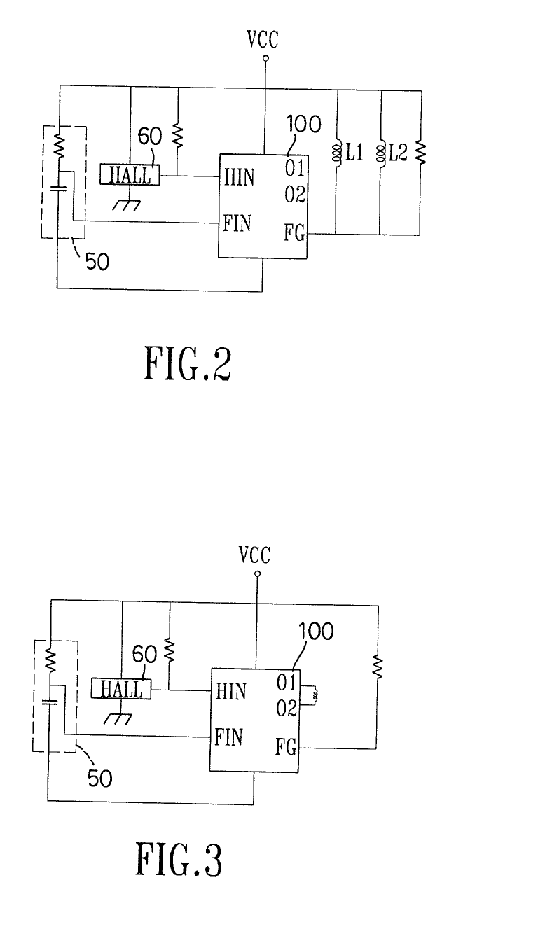

The timing control circuit (10) receives a “Hall signal” (HIN) from a Hall element (60) (shown in FIGS. 2 and 3) so as to detect immediate rotational speed of a fan. The driving circuit (20) is controlled by the timing control circuit (10) so as to drive coils of the fan. The signal comparing circuit (30) receives an external frequency signal (FIN) and a timing signal from the timing control circuit (10). The signal generating circuit (40) is used to generate a clock signal. The detailed description of the constant speed control circuit (100) is provided below.

An input terminal of the timing control circuit (10) is connected to the Hall element (60) that is used to detect the polarity variation of the fan so as to generate the Hall signal. Conventionally, the timing control circuit (10) directly depends on the Hall signal to control a rotational speed of the fan.

However, in the present invention, the Hall signal is inputted to the timing control circuit (10), and the timing control circuit (10) according to the Hall signal generates a timing signal (TS) The timing signal (TS) and the external frequency signal (FIN) are inputted to the signal comparing circuit (30) for a signal comparing process. By comparing the Hall signal and the external frequency signal, the signal comparing circuit (30) obtains an correction output signal (AS) and outputs the correction output signal to the timing control circuit (10). The timing control circuit (10) according to the correction output signal controls the driving circuit (20) for driving the fan in a steady operation, wherein the driving circuit (20) has two output terminals (01 and 02) used to connect to a pair of coils or a single coil of the fan.

In the present invention, the signal comparing circuit (30) is an important unit for adjusting the rotation speed of the fan, wherein a frequency signal generator (50) is connected to a reference signal terminal of the signal comparing circuit (30) for providing the external frequency signal (FIN). Because the Hall signal is obtained by detecting a polarity variation of the fan, and the timing signal (TS) is related to the Hall signal, the timing signal (TS) represents the rotational speed of the fan. Furthermore, the external frequency signal generated from the frequency signal generator (50) represents an expected rotational speed of the fan. Thus by comparing the timing signal (TS) and the external frequency signal (FIN), the rotational speed of the fan is gradually adjusted to achieve the expected rotational speed.

According to the above description, the external frequency signal is an important factor that is used to decide the expected rotational speed, wherein the frequency signal generator (50) is an oscillator, such as a crystal oscillator, a ceramics oscillator, a surface audio wave (SAW) oscillator or an oscillator composed of a resistor and a capacitor.

With reference to FIG. 2, the constant speed control circuit (100) is applied to control a pair of coils (L1 and L2) of the fan, wherein the output terminals (O1 and O2) are respectively connected to coils (L1 and L2), and the coils (L1 and L2) are further connected to a power supply (VCC). In FIG. 2, the frequency signal generator (50) is composed of a resistor and a capacitor. By changing a resistance value or capacitance value, the expected rotational speed is easily achieved.

With reference to FIG. 3, the constant speed control circuit (100) is applied to control a single coil (L), wherein both the output terminals (O1 and O2) are connected to the coil (L), and the frequency signal generator (50) is composed of a resistor and a capacitor.

According to the above description, the present invention has the following advantages:

1. The rotational speed is easily controlled by setting an expected external frequency signal, and when the external frequency signal is set at a fixed value, the rotational speed of the fan is retained at a constant speed.

2. The rotational speed of the fan does not vary due to changes in temperature and friction of bearings.

3. Manufacturers do not need to fabricate different models of fan having different specifications (rotational speed) to match different working environments.

4. The constant speed control circuit is fabricated as an integrated circuit, hence the volume of the circuit is small.

Although the present invention has been explained in relation to its preferred embodiment, it is to be understood that many other possible modifications and variations can be made without departing from the spirit and scope of the invention as hereinafter claimed.

What is claimed is:

1. A constant speed control circuit for a fan comprising:
a timing control circuit for receiving a Hall signal from a Hall element that is used for detecting a rotational speed of a fan;
a driving circuit connected to an output terminal of the timing control circuit for driving the fan, and having output terminals for connection with the fan;
a signal comparing circuit connected to the timing control circuit, and having a reference signal terminal connected to a frequency signal generator, wherein the signal comparing circuit compares a timing signal from the timing control circuit with an external frequency signal from the frequency signal generator so as to output a correction output signal to the timing control circuit for controlling an output terminal of the driving circuit to drive the fan at a constant rotating speed.

2. The constant speed control circuit for a fan as claimed in claim 1, wherein the frequency signal generator is composed of a resistor and a capacitor.

3. The constant speed control circuit for a fan as claimed in claim 1, wherein the frequency signal generator is an oscillator.

4. The constant speed control circuit for a fan as claimed in claim 3, wherein the oscillator is a crystal oscillator.

5. The constant speed control circuit for a fan as claimed in claim 3, wherein the oscillator is a ceramics oscillator.

6. The constant speed control circuit for a fan as claimed in claim 3, wherein the oscillator is a surface audio wave (SAW) oscillator.

7. The constant speed control circuit for a fan as claimed in claim 1, wherein a signal generating circuit is connected the output terminal of the timing control circuit for generating a clock signal.

8. The constant speed control circuit for a fan as claimed in claim 1 being an integrated circuit.
